(19) United States
(12) Patent Application Publication
(10) Pub. No.: US 2003/0210841 A1
(43) Pub. Date: Nov. 13, 2003

(54) Bearing seat

(75) Inventors: Hans Linden, Ytterby (SE); Folke Ostling, Goteborg (SE)

Correspondence Address: BURNS, DOANE, SWECKER & MATHIS, L.L.P., P.O. Box 1404, Alexandria, VA, 22313-1404, US

(73) Assignee: Aktiebolaget SKF

(21) Appl. No.: 10/392,086

(22) Filed: Mar. 20, 2003

(30) Foreign Application Priority Data
Mar. 20, 2002 (SE) 0200884-5

(51) Int. Cl. F16C 43/00

(52) U.S. Cl. 384/537

(57) ABSTRACT

A bearing seat provided in or on a cylindrical surface of a component to which the bearing is to be mounted is constructed so that the component at which the bearing seat is provided is softer at least in the surface region than the ring(s) of the bearing that is to be interconnected to the component via the bearing seat. In addition, either one of the bearing seat and the bearing ring in their surfaces facing each other has a number of surface irregularities arranged ring to cause deformation to the softer surface region under a mutual axial mounting motion between the bearing seat and the bearing ring to thereby form a mutual grip between the seat and the bearing ring.

This application is based on and claims priority under 35 U.S.C. § 119 with respect to Swedish Patent Application No. 0200884-5 filed on Mar. 20, 2002, the entire content of which is incorporated herein by reference.

### FIELD OF THE INVENTION

The present invention generally relates to bearing seats. More particularly, the invention pertains to a bearing seat provided in or on a cylindrical surface of a component to which a bearing is to be mounted.

### BACKGROUND OF THE INVENTION

Bearings are commonly used in combination with different types of bearing housings, or other components in which the bearing is mounted in or on a seat in the housing or component in such a manner that the bearing is retained in the mounted position without being able to rotate in relation to the seat. It is also sometimes desirable that the bearing ring or rings shall not be axially movable in or on the seat unless subjected to intentional dismounting measures. Different types of attachment mechanisms have been used to effect this retainment of the bearing, such as tapering adapter sleeves and the like. These attachment mechanisms result in an increased number of components in the bearing assembly and therefore increased costs. Interference fits have also been used, thus requiring close manufacturing tolerances and special mounting and dismounting appliances and/or tools. Such accurate machining of the components results in increased manufacturing cost. In addition, the need for mounting and dismounting appliances and tools also increases the handling work which once again increases the costs.

### SUMMARY OF THE INVENTION

One aspect of the invention involves a component comprising a surface provided with a bearing seat, and a bearing adapted to be mounted at the bearing seat, with the bearing having at least one bearing ring, and the at least one bearing ring and the bearing seat having facing surfaces adapted to face one another when the bearing is mounted at the bearing seat. At least a surface region of the bearing seat of the component is softer than the at least one bearing ring of the bearing, and one of the facing surfaces of the seat and the bearing ring have a plurality of spaced apart raised regions so that deformation to the softer surface region occurs during mounting of the bearing at the bearing seat to produce a mutual grip between the seat and the at least one bearing ring.

According to another aspect, a bearing seat is provided in or on a cylindrical surface of a component to which a bearing is to be mounted, with the component at which the bearing seat is provided being softer at least in a surface region than a ring of the bearing that is to be interconnected with the component via the seat. In addition, either one of the bearing seat and the ring of the bearing in surfaces facing each other have a number of surface irregularities arranged to cause deformation to the softer surface region under a mutual axial mounting motion between the bearing seat and the bearing ring to thereby form a mutual grip between the bearing seat and the ring of the bearing.

### BRIEF DESCRIPTION OF THE DRAWING FIGURES

The foregoing and additional features and characteristics of a preferred embodiment of the present invention will become more apparent from the following detailed description considered with reference to the accompanying drawing figures in which like reference numerals designate like elements.

FIG. 1 is a schematic side view of a bearing to be mounted in a split component forming two cooperating bearing seat portions.

FIG. 2 schematically illustrates the upper half of a bearing fitted to a shaft and mounted in a simple housing.

FIG. 3 is a cross-sectional end view of a one-piece cylindrical bearing housing and a bearing (shown as a circular member) positioned therein.

FIG. 4 is a schematic illustration of one example of a surface texture or surface irregularities of at least one of the cooperating surfaces of the bearing and component to which the bearing is to be interconnected.

FIG. 5 is a schematic illustration of a different example of a surface texture or surface irregularities of at least one of the cooperating surfaces of the bearing and component to which the bearing is to be interconnected.

FIG. 6 is a schematic illustration of another example of a surface texture or surface irregularities of at least one of the cooperating surfaces of the bearing and component to which the bearing is to be interconnected.

FIG. 7 is an exploded perspective view of a bearing, and inner and outer components to which the bearing is to be mounted.

### DETAILED DESCRIPTION

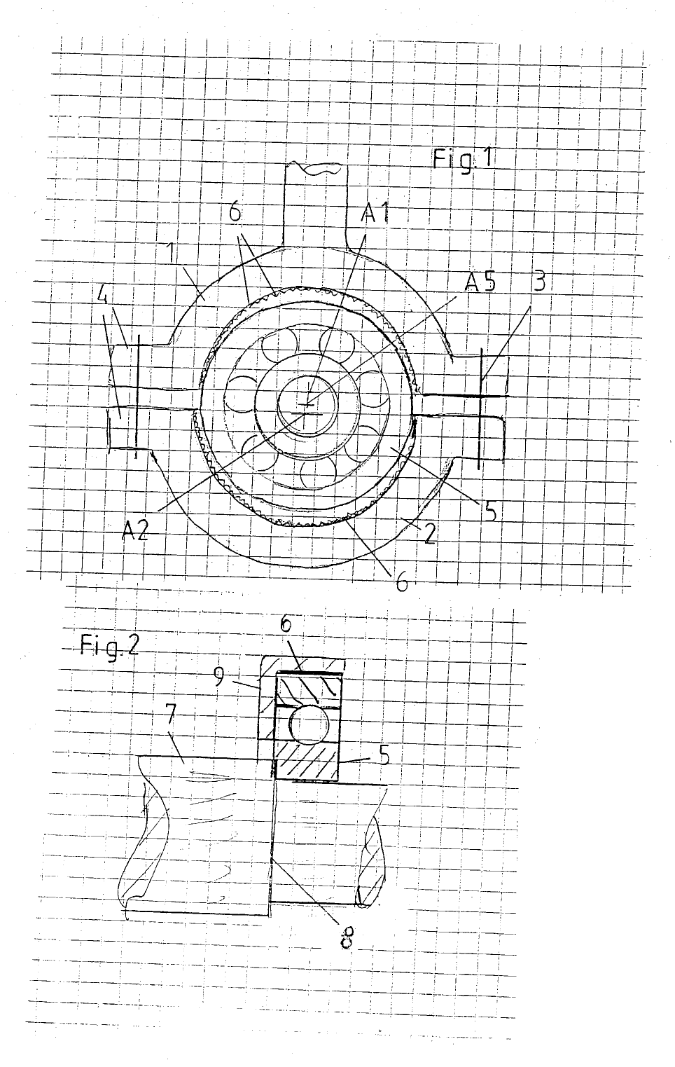

Referring initially to FIG. 1, a split bearing housing includes an upper and a lower, substantially semi-spherical, bearing housing half 1, 2. These bearing housing halves or parts are intended to be interconnected by way of bolts 3 or other suitable mechanisms which pass through bores in lugs 4 that project radially outwardly from the open edges of the semi-spherical bearing housing parts 1, 2. The split bearing housing encloses a bearing 5. In the illustrated embodiment, the bearing 5 is a ball bearing, although the bearing 5 can be any type of standard rolling or sliding bearing.

At least the internal surfaces of the housing parts 1, 2 which face the bearing 5 are produced to have a lower hardness than the bearing 5. The internal surfaces of the housing parts 1, 2 which face the bearing 5 are also shaped or provided with surface irregularities 6. In the illustrated embodiment, the surface irregularities 6 are in the form of spaced apart raised regions which can be formed as grooves and ridges, serrations, splines or the like extending substantially in the axial direction of the bearing 5. The housing parts 1, 2 are preferably made as sintered press bodies of metal powder, although they could also be manufactured as bodies of cast material, e.g. from aluminium or other alloys or materials that are softer than the material of the bearing ring.

In FIG. 1, the two bearing housing parts 1, 2 are shown with a certain mutual distance to better illustrate the relationship between the components. When the bolt joints 3 or the like are tightened, so that the gap between the lugs 4 of the housing parts 1 and 2 is reduced or eliminated, and the lugs 4 are in close or generally close contact with each other, the surfaced irregularities 6 are brought in close contact with the harder material of the outer race ring of the bearing 5. The surface irregularities 6 are thus deformed, with the softer material embracing the bearing and keeping it in the mounted position to thereby inhibit or prevent the bearing 5 from undergoing rotational movements in the bearing housing as well as axial motions in the housing, until a displacement force required for further deforming the softer material intentionally has been applied to the bearing for allowing it to be dismounted.

FIG. 1 also shows that the axes A1, A2, AS of the different components 1, 2, 5 might be offset from each other, with the deformation of the softer material compensating for such initial misalignments to a certain extent. This also means that the requirements for manufacturing tolerances can be kept at a comparatively low level, when it comes to the manufacture of the bearing housing halves. In addition, this also makes it possible to use bearings which, due to certain outer ring defects, might otherwise have been rejected or unusable as at least some of those defects can be compensated by the deformation of the softer material during the mounting operation. It is thus possible to achieve a less expensive and yet reliable mounting. I addition, it is possible to use components having less accurate tolerances which also contributes to a lowering of costs.

FIG. 2 illustrates a side view a portion of a shaft 7, and also illustrates in cross-section one half of a ball bearing 5 mounted with its inner ring on the shaft 7, against a shoulder 8. FIG. 2 also illustrates a simple, cup-shaped housing 9 (only a half of which is shown) in which the outer ring of the bearing 5 is mounted. Also in this embodiment, the seat in the housing 9 is of a softer material than the bearing 5 itself, and the outer peripheral or envelope surface of the outer ring of the bearing 5 preferably has a number of surface irregularities 6 extending substantially in the axial direction. It is also possible though that the surface irregularities extend at an angle to the axial direction. The surface irregularities might even be provided in the inner envelope surface of the housing itself.

As the housing 9 in this illustrated embodiment is shaped as a one-piece cup, it cannot be interconnected with the bearing in the same manner as in the embodiment according to FIG. 1 in which the two halves of the two-piece housing are mounted around the bearing by being tightened against each other in radial direction, thereby causing deformation of the softer material required for creating a firm grip between the bearing and the seat. Therefore, in the embodiment shown in FIG. 2, the bearing 5 has to be pushed axially into the housing (or vice versa), whereby the surface irregularities 6 cause a deformation of the softer material, either the surface irregularities are provided in the surface of the housing or in the bearing. Even in this case, the bearing 5 will be relatively securely arrested against rotating in the seat of the housing 9, although the grip inhibiting or preventing axial displacement in the housing may be somewhat less effective as compared to the embodiment shown in FIG. 1, where the material deforming force is applied radially.

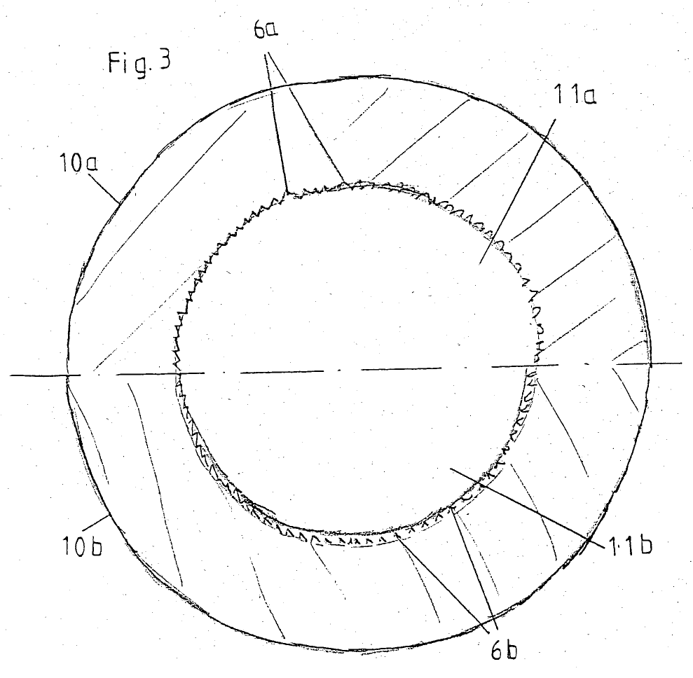

FIG. 3 shows by way of a schematic end view an external, one-piece housing which is shown in two slightly different embodiments, one embodiments 10a illustrated above the horizontal and the other embodiments 10b illustrated below the horizontal. A bearing 11a, 11b, which for purposes of simplicity is depicted as a circular surface, is inserted or positioned in the housing 10a, 10b. In the upper embodiment, the outer envelope or outer peripheral surface of the outer ring of the bearing 11a is provided with a plurality of substantially or generally axially extending surface irregularities 6a in the form of grooves and ridges, serrations, splines or the like. When the bearing 11a is pushed axially into the housing 10a, these surface irregularities will cut grooves in the softer material of the inner envelope surface, thereby causing deformation of this material and creating a grip between the bearing and the housing, thus primarily inhibiting or preventing rotation of the bearing in the seat in the housing 10a.

The embodiment depicted in the lower half of FIG. 3 shows how the seat in the bearing housing 10b is provided with inwardly projecting irregularities 6b extending primarily or generally in the axial direction. These surface irregularities are subjected to an axial force when the bearing 11b with its harder outer ring is pushed into the seat in the housing 10b. This axial force will cause the softer material in the inner envelope surface of the bearing housing 10b to be deformed when the bearing is pushed in, thereby creating a grip to retain the bearing in the mounted position in the seat until a larger axial force is applied for continuing the deformation of the material in the softer surface portion, thereby releasing the grip.

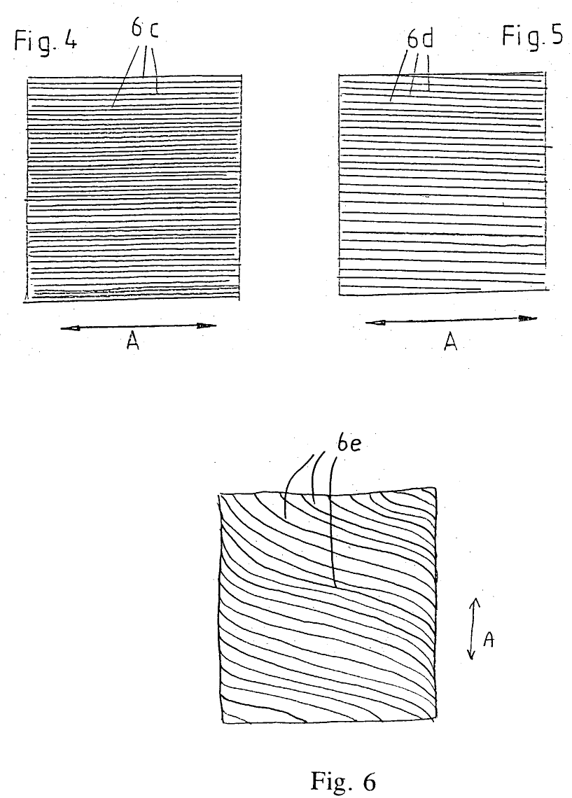

FIG. 4 shows in plan view one example of the surface irregularities 6c in the inner envelope surface of the seat in the housing or the outer envelope surface of the bearing ring. In this embodiment, the surface is covered with a large number of grooves and ridges, serrations splines or the like extending truly axially along the surface, with the axial direction being marked as A.

FIG. 5 is a plan view similar to FIG. 4 illustrating another example of the surface irregularities 6d which here are shown to extend slightly inclined with respect to the axial direction A of the envelope surface.

It is of course also possible to configure the surface irregularities so that they extend at angles other than that shown in FIG. 5, it being recognized that a larger angle in relation to the axial direction will require a greater pushing-in force. It is also possible that the angle between the groove, serration or the like and the axial direction can vary, so that a somewhat helical extension is obtained, whereby the bearing can be “screwed” into the seat in the bearing housing at mounting. FIG. 6 illustrates an example of surface irregularities 6e forming a helical extension.

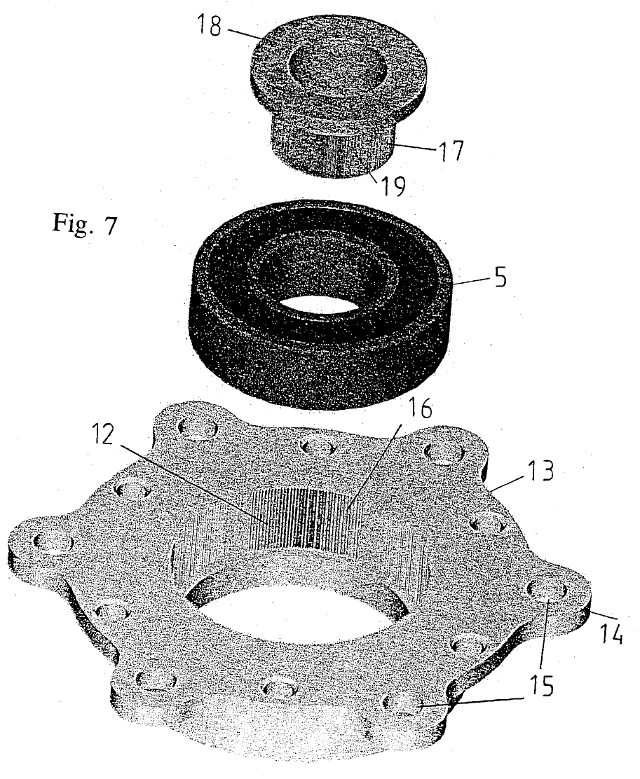

FIG. 7 shows a sealed bearing 5 intended to be mounted with its outer ring in a seat 12 in the inner envelope surface of an external bearing housing 13. In the-illustrated embodiment, the external bearing housing 13 is designed with external flanges 14 provided with attachment holes 15 for attachment of the housing to a machine part or an implement of any appropriate type. The seat 12 is equipped with axially extending surface irregularities 16 which are in the form of serrations in this illustrated embodiment. These surface irregularities 16 act in a manner similar to the surface irregularities 6 mentioned and described above in connection with the earlier described embodiments of the invention. The housing 13 has a rather complex shape, but can preferably be manufactured as a component in the form of a sintered powder pressed body so that the component can be obtained or produced with a minimum of machining. The material in the bearing housing 13 is softer than that of the bearing rings themselves. When pushed in axially, the bearing 5 will therefore cause deformation of the surface irregularities 16 in the seat 12, thereby arresting the bearing in the bearing housing 13, particularly against rotation in the seat. This particular embodiment also illustrates how a seat 17 can be provided for the bearing 5 at the outer envelope surface of a sleeve 18, which can be used as a shaft journal or a connection to another part of a non-rotating or rotating machine member.

The sleeve 18 is preferably, though not necessarily, made from a sintered press body, and has a lower hardness than the bearing rings. The seat 17 on the outer envelope or outer peripheral surface of the sleeve 18 is provided with axially extending surface irregularities 19 which, due to the lower hardness of the sleeve, will be deformed when pushed into the bearing 5, thus generating a firm grip between the bearing and the sleeve. This grip can, however, be released by additional forces acting in the opposite direction and causing a further deformation of the softer material.

It is to be understood that the invention is not limited to the particular embodiments illustrated and described above, as modifications and variants are possible within the scope of the inventions. Thus, for example, it is possible to use seats provided in components, which are not sintered press bodies, but which can be made from cast aluminium or the like. It is also possible to use housing components made from other materials softer than the material in the bearing rings. As illustrated in the embodiment according to FIG. 7, the same mounting can be used both with respect to the inner and the outer ring, and in spite of the fact that the different embodiments have shown either mountings with the deformable surface irregularities either on the outer or on the outer and the inner bearing envelope surface, it is evident that the same type of mounting can be used also for the inner bearing ring only.

A bearing seat is thus provided which, in accordance with preferred embodiments, allows the bearing to be mounted in the seat in a simple and efficient manner, without necessarily requiring close manufacturing tolerances to the same extent as previously required and without necessarily requiring additional appliances to the same extent as previously required. In the various embodiments described above and illustrated in the drawing figures, the surface irregularities define a surface that is other than smooth, a surface possessing an undulating appearance, for example grooves and ridges, capable of causing deformation of the softer material in the manner described in connection with the preferred embodiments.

The principles, preferred embodiments and modes of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims be embraced thereby.

What is claimed is:

1. A component comprising a surface provided with a bearing seat, and a bearing adapted to be mounted at the bearing seat, the bearing having at least one bearing ring, with the at least one bearing ring and the bearing seat having facing surfaces adapted to face one another when the bearing is mounted at the bearing seat, at least a surface region of the bearing seat of the component being softer than the at least one bearing ring of the bearing, and one of the facing surfaces of the seat and the bearing ring having a plurality of spaced apart raised regions so that deformation to the softer surface region occurs during mounting of the bearing at the bearing seat to produce a mutual grip between the seat and the at least one bearing ring.

2. The component according to claim 1, wherein at least the surface region of the bearing seat of the component is made from a sintered material.

3. The component according to claim 1, wherein the component is made from sintered material.

4. The component according to claim 1, wherein the at least one bearing ring is an outer race ring of the bearing and the component is a bearing housing provided with the bearing seat formed as an internal, substantially cylindrical bearing seat in which the outer race ring of the bearing is positionable.

5. The component according to claim 1, wherein the at least one bearing ring is an inner race ring of the bearing and the component is a sleeve provided with the bearing seat formed as an external, substantially cylindrical bearing seat on which is to be pushed the inner race ring of the bearing.

6. The component according to claim 1, wherein the spaced apart raised regions are axially extending grooves and ridges.

7. The component according to claim 1, wherein the spaced apart raised regions are grooves and ridges extending at an angle to an axial direction of the seat or the bearing ring.

8. The component according to claim 7, wherein the grooves and ridges extend helically along one of the facing surfaces of the seat and the bearing ring.

9. A bearing seat provided in or on a cylindrical surface of a component to which a bearing is to be mounted, the component at which the bearing seat is provided being softer at least in a surface region than a ring of the bearing that is to be interconnected with the component via the seat, either one of the bearing seat and the ring of the bearing in surfaces facing each other having a number of surface irregularities arranged to cause a deformation to the softer surface region under a mutual axial mounting motion between the bearing seat and the bearing ring to thereby form a mutual grip between the bearing seat and the ring of the bearing.

10. The bearing seat as claimed in claim 9, wherein the component in or on which the bearing seat has at least a surface region made from a sintered material.

11. The bearing seat as claimed in claim 10, wherein the bearing ring is an outer race ring of the bearing, and the component is a bearing housing provided with the bearing seat formed as an internal, substantially cylindrical bearing seat in which the outer race ring of the bearing is insertable.

12. The bearing seat as claimed in claim 10, wherein the bearing ring is an inner race ring of the bearing, and the component is a sleeve provided with the bearing seat formed as an external, substantially cylindrical bearing seat on which the inner race ring of the bearing can be pushed up.

13. The bearing seat as claimed in claim 9, wherein the component in or on which the bearing seat is provided is made from sintered material.

14. The bearing seat as claimed in claim 13, wherein the bearing ring is an outer race ring of the bearing, and the component is a bearing housing provided with the bearing seat formed as an internal, substantially cylindrical bearing seat in which the outer race ring of the bearing is insertable.

15. The bearing seat as claimed in claim 13, wherein the bearing ring is an inner race ring of the bearing, and the component is a sleeve provided with the bearing seat formed as an external, substantially cylindrical bearing seat on which the inner race ring of the bearing can be pushed up.

16. The bearing seat as claimed in claim 9, wherein the surface irregularities are axially extending grooves and ridges.

17. The bearing seat as claimed in claim 9, wherein the surface irregularities are grooves and ridges extending at an angle to an axial direction of the bearing seat or the bearing ring.

18. The bearing seat as claimed in claim 17, wherein the grooves and ridges extend helically along one of the facing surfaces of the seat and the bearing ring.
